(19) United States
(12) Patent Application Publication
(10) Pub. No.: US 2018/0238427 A1
(43) Pub. Date: Aug. 23, 2018

(54) DOUBLE GEARBOX, AND METHOD FOR ENGAGING AN OVERALL GEAR RATIO THEREIN

(71) Applicant: ZF Friedrichshafen AG, Friedrichshafen (DE)

(72) Inventors: Christian MITTELBERGER, Ravensburg (DE); Stefan BLATTNER, Vogt (DE)

(21) Appl. No.: 15/759,904

(22) PCT Filed: Aug. 24, 2016
(86) PCT No.: PCT/EP2016/069934

§ 371 Date: Mar. 14, 2018

(30) Foreign Application Priority Data
Sep. 18, 2015 (DE) 10 2015 218 022.0

(51) Int. Cl. F16H 37/04; F16H 3/00; F16H 3/095; F16H 3/54

(52) U.S. Cl. CPC F16H 37/046; F16H 3/006; F16H 3/095; F16H 2200/2035; F16H 2200/0078; F16H 2200/0091; F16H 2200/2005; F16H 3/54

(57) ABSTRACT

A double clutch transmission having a first and a second input shaft; a countershaft; a drive output shaft; a first sub-transmission having two gearsets, of which one gearset can be selectively connected to transmit torque between the first input shaft and the countershaft; a second sub-transmission having two gearsets, of which one gearset can be selectively connected to transmit torque between the second input shaft and the countershaft; and a third sub-transmission having one gearset which can be connected to transmit torque between the countershaft and the drive output shaft. In this case, one of the gearsets of the first sub-transmission coincides with one of the gearsets of the second sub-transmission.

This application is a National Stage completion of PCT/EP2016/069934 filed Aug. 24, 2016, which claims priority from German patent application serial no. 10 2015 218 022.0 filed Sep. 18, 2015.

### FIELD OF THE INVENTION

The invention concerns a shiftable double transmission with intermediate gearing, preferably for a utility vehicle.

### BACKGROUND OF THE INVENTION

A double transmission comprises a first and a second input shaft, each of which can be coupled to a drive input shaft for the transmission of torque by way of an associated friction clutch, the drive input shaft being connected for example to an internal combustion engine. With each input shaft is associated a sub-transmission which usually has a plurality of gearsets that can be engaged in alternation between the input shaft concerned and a countershaft. A further sub-transmission usually comprises a plurality of gearsets which can be engaged between the countershaft and the drive output shaft. By virtue of the shiftable gearsets and the clutches, various overall gear ratios can be engaged between the driveshaft and the drive output shaft.

To carry out a gearshift free from traction force interruption between a first and a second engaged overall gear ratio, between in each case one of the two respective input shafts and the output shaft various gearsets are engaged, wherein however only one of the friction clutches is closed. Then the closed friction clutch is opened and the open friction clutch is closed.

DE 10 2012 213 517 A1 relates to a dual clutch transmission with intermediate gearing for utility vehicles. In addition to the three above-mentioned sub-transmissions a shiftable connection between the first input shaft and the output shaft is possible. In combination with a downstream group transmission that can be shifted in two stages, twelve forward gears and four reversing gears can be obtained.

DE 2012 217 503 A1 shows a transmission of similar configuration, which enables eleven forward and four reversing gears to be engaged without traction force interruption.

DE 10 2013 222 510 A1 shows another dual clutch transmission with intermediate gearing.

### SUMMARY OF THE INVENTION

The purpose of the present invention is to indicate an improved double transmission with intermediate gearing and a better control method for the double transmission. The invention achieves these objectives by virtue of the characteristics specified in the independent claims. Preferred embodiments are described in the subordinate claims.

A double transmission comprises a first and a second input shaft; a countershaft; a drive output shaft; a first sub-transmission having at least two gearsets, of which selectively one can be connected to transmit torque between the first input shaft and the countershaft; a second sub-transmission having at least two gearsets, of which selectively one can be connected to transmit torque between the second input shaft and the countershaft; and a third sub-transmission having at least one gearset, which can be connected to transmit torque between the countershaft and the drive output shaft. In this case, one of the gearsets of the first sub-transmission coincides with one of the gearsets of the second sub-transmission.

The double transmission can in particular be used for a utility vehicle, wherein a gearshift free from traction force interruption between various gear ratios can for example have consumption advantages for the drive motor connected to the transmission. Thanks to the double utilization of one of the gearsets for the first and for the second sub-transmission, the number of gearsets and thus also the number of wheel planes of the double transmission can be reduced. In that way the double transmission can be made more compact or lighter. If the first and second sub-transmissions together have three gearsets and the third sub-transmission has a further two gearsets, then with a total of five wheel planes six overall gear ratios can be obtained with the double transmission. The first and the second sub-transmission can also have more than two gearsets independently of one another.

In a particularly preferred embodiment, a shifting element is also provided in order to connect the first input shaft for the transmission of torque to a first intermediate shaft, which acts upon the drive output shaft. If the intermediate shaft is connected directly to the drive output shaft, then by actuating the shifting element a direct gear can be obtained, in which the rotational speed of the first input shaft is the same as the rotational speed of the drive output shaft. In addition, by means of the first two sub-transmissions a reduction ratio can be produced between the second input shaft and the first input shaft. For this, in the first two sub-transmissions different gear ratios are engaged, so enabling a torque flow from the second input shaft, via the second sub-transmission, to the countershaft and from there, via the first sub-transmission, to the first input shaft. In that way additional overall gear ratios of the double transmission can be obtained. An overall gear ratio in which the shifting element between the first input shaft and the first intermediate shaft is closed, is also known as a coupling gear.

In a further preferred embodiment, the third sub-transmission comprises at least two gearsets, of which one can optionally be connected to transmit torque between the countershaft and the drive output shaft and wherein one of the gearsets is preferably non-reversing (i.e. it maintains its rotational direction), whereas it is also preferable for at least one of the other gearsets to be reversing (i.e. it can reverse its rotational direction). By virtue of the gearsets associated with it, the third sub-transmission produces various drive output constants by way of which the countershaft can be coupled to the drive output shaft. In the torque flow between one of the input shafts and one of the intermediate shafts there are usually no reversing gearsets or two reversing gearsets, so that the rotational directions of the input shaft and the intermediate shaft are the same. If a reversing and a non-reversing gearset are in the torque flow, then a negative overall gear ratio is produced so that a reversing gear can be obtained.

Building on the above-described double transmission, various variants can be formed. In a first variant a group transmission with two gearsets is provided in addition, of which either one or the other can be connected to transmit torque between the first intermediate shaft and the drive output shaft. In that way the number of overall gear ratios of the double transmission can be doubled. It is particularly preferred that the group transmission can be powershifted in order to make it possible for an overall gearshift free from traction force interruption to be carried out between any consecutive overall gear ratios of the double transmission. In total the double transmission can thereby produce twice-seven overall gear ratios, not counting the reversing gears.

In a preferred embodiment the group transmission comprises a planetary gearset with a sun gear, a planetary gear and a ring gear. In this case the sun gear is permanently connected to the first intermediate shaft and the planetary gear to the drive output shaft. The ring gear can be shifted either to idle or to be connected to the first intermediate shaft in a torque-transmitting manner. If both the sun gear and the ring gear are connected to the first intermediate shaft, then the step-down ratio of the planetary gearset is equal to 1. In contrast, if the ring gear is idling, then there is a positive reduction ratio between the first intermediate shaft and the drive output shaft.

In another variant a further shifting element is provided, in order to connect a gearset of the third sub-transmission to transmit torque to a second intermediate shaft. In addition a group transmission is provided, which comprises two gearsets, of which, either one can be connected to transmit torque between the first intermediate shaft and the drive output shaft, or the other can be connected to transmit torque between the second intermediate shaft and the drive output shaft. Thus, torque can be transmitted between the main transmission with the three sub-transmissions and the group transmission by way of two different intermediate shafts, whereby advantageous shifting combinations can be made possible.

Preferably, this group transmission also comprises a planetary gearset with a sun gear, a planetary gear and a ring gear. In particular the sun gear can be permanently connected to the first intermediate shaft and the planetary gear to the drive output shaft. In this case the ring gear can either idle or be connected to transmit torque to the drive output shaft. If both the ring gear and the planetary gear or a planetary carrier are connected to the drive output shaft, then the step-down ratio of the group transmission is equal to one. If the ring gear is idling, then the gear ratio of the group transmission is positive.

In general a gearset of one of the sub-transmissions preferably comprises a spur gear system with at least two gearwheels. The gearwheels mesh with one another and usually have different radii in order to produce a step-up or a step-down ratio. Other embodiments are also possible, for example by means of an epicyclic gearset.

The two gearwheels are usually mounted on different shafts in such manner that an engagement between a shaft and an associated gearwheel can be permanent or releasable. For a releasable engagement a shifting element is usually used, which forms or separates an interlocked connection between one of the gearwheels and a shaft. The shifting element can in particular comprise a sliding sleeve which, for example, is connected to the shaft with interlock in the circumferential direction by gearteeth but can be displaced axially. In a first position the sliding sleeve can engage with interlock in a gearwheel on the same shaft and in a second position it can leave the gearwheel free. In relation to the shaft the gearwheel is a loose wheel so that it can rotate freely about the shaft when not engaged by the shifting element. In relation to its associated shaft, a gearwheel with which the loose wheel meshes is usually a fixed wheel and is therefore permanently in torque-transmitting connection with its shaft. In this case the connection can be optionally interlocking, frictional, or material-merged. In general, none of the gearwheels can be displaced axially relative to its associated shaft.

The shifting element described can also be used in a third axial position to form a torque-transmitting connection between a further loose wheel and the shaft. The position of the sliding sleeve in which there is no interlock with either of the loose wheels on the shaft is usually between the positions in which there is engagement with a respective gearwheel. Thus, two shifting elements can be made integrally with one another. In a corresponding manner a shifting element can also be used to form a separate torque-transmitting connection between two shafts. For this the shafts are preferably arranged coaxially and particularly preferably end to end opposite one another. A sliding sleeve connected to one of the shafts in a torque-transmitting manner can be brought axially into interlocking engagement with the other shaft, in order to close the shifting element. In another embodiment one of the shafts can also be axially movable in order to form or separate a shiftable engagement with the other shaft.

In a particularly preferred embodiment, the double transmission also comprises a first friction clutch for connecting a drive input shaft to the first input shaft and a second friction clutch for connecting the drive input shaft to the second input shaft. In this case the double transmission can also be called a dual-clutch transmission. The double transmission or its shifting elements and the friction clutches can be controlled by a common control unit. In that way sequential control when shifting the double transmission between different overall gear ratios, in particular without interrupting the traction force between the drive input shaft and the drive output shaft, can be improved. The entire double transmission with the dual clutch can be designed as a separately handled unit, for example to be used in a motor vehicle, in particular a utility vehicle.

A method for engaging an overall gear ratio in the above-described double transmission with a dual clutch comprises the steps of engaging a first overall gear ratio between one of the input shafts and the drive output shaft and a second overall gear ratio between the other input shaft and the drive output shaft, and controlling a shift from the first to the second overall gear ratio by means of the friction clutches. In this, in each case the overall gear ratios are engaged in one of two ways. In the first way just one of the gearsets of the first or second sub-transmission is connected to transmit torque between one of the input shafts and the countershaft and just one gearset of the third sub-transmission is connected to transmit torque between the countershaft and the first intermediate shaft. In the second way just one gearset of the second sub-transmission is connected to transmit torque between the second input shaft and the countershaft. In addition just one gearset of the first sub-transmission is connected to transmit torque between the countershaft and the second input shaft, and the first input shaft is connected to transmit torque to the first intermediate shaft. By means of this procedure many of the physically possible overall gear ratios of the double transmission can be engaged without traction force interruption. Combinations of overall gear ratios with which this is not possible can nevertheless be obtained without traction force interruption by briefly engaging another overall gear ratio (“supporting gear”), as explained in greater detail below.

### BRIEF DESCRIPTION OF THE DRAWINGS

The invention will now be described in greater detail with reference to the attached figures, which show:

FIG. 1: A schematic representation of a dual-clutch transmission, in a first embodiment;

FIG. 2: A shifting matrix for the dual-clutch transmission of FIG. 1;

FIG. 3: An alternative shifting matrix for the dual-clutch transmission of FIG. 1;

FIG. 4: A dual-clutch transmission according to FIG. 1 in a second embodiment;

FIG. 5: A shifting matrix for the dual-clutch transmission of FIG. 4;

FIG. 6: An alternative shifting matrix for the dual-clutch transmission of FIG. 4; and

FIG. 7: A dual-clutch transmission according to FIG. 1, in a third embodiment.

### DETAILED DESCRIPTION OF THE PREFERRED EMBODIMENTS

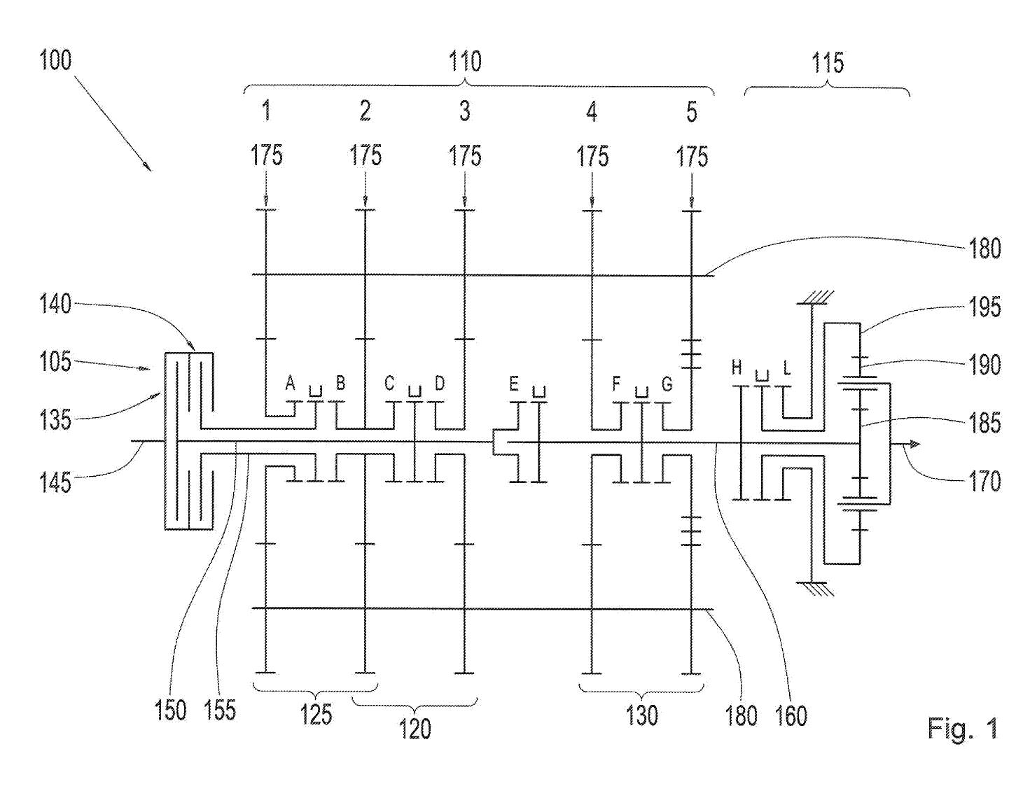

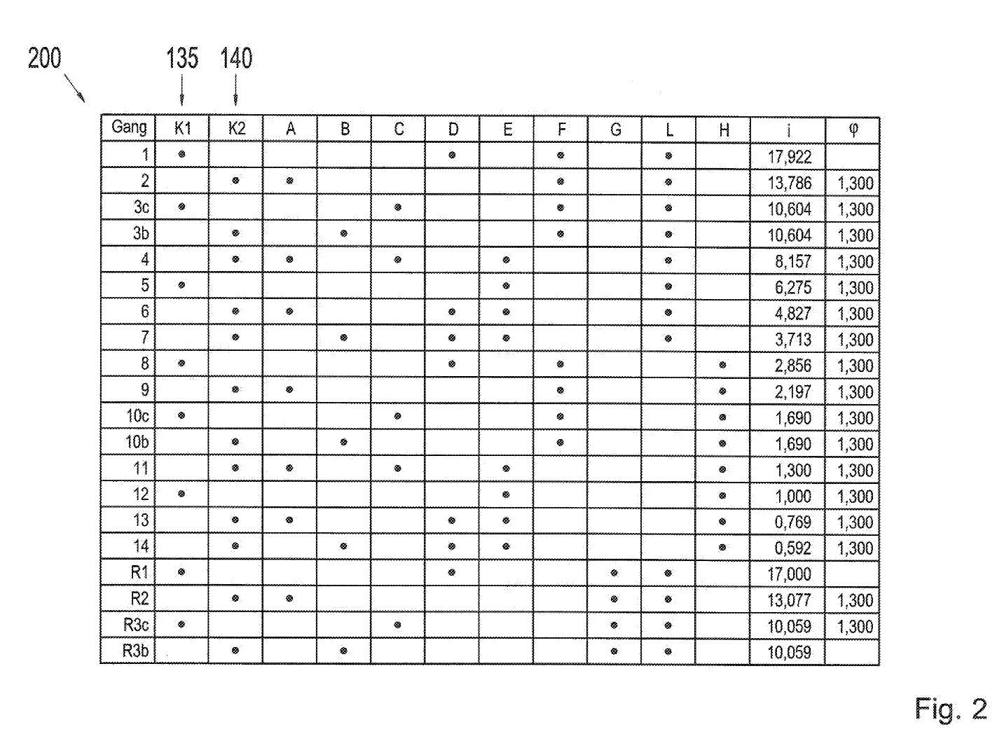

FIG. 1 shows a dual-clutch transmission 100, in a first embodiment. The dual-clutch transmission 100 comprises a dual clutch 105, a double transmission 110 and an optional group transmission 115. The dual clutch 105 and the double transmission 110 can be made and used separately from one another, or made integrally with one another. The double transmission 110, also called the main transmission, comprises a first sub-transmission 120, a second sub-transmission 125 and a third sub-transmission 130. The dual clutch 105 comprises a first friction clutch 135 and a second friction clutch 140. A drive input shaft 145 of the dual clutch 105 can be continuously variably, frictionally connected by means of the first friction clutch 135 to a first input shaft 150 of the double transmission 110 and, independently of that, continuously variably, frictionally connected by means of the second friction clutch 140 to a second input shaft 155 of the double transmission 110. Usually the input shafts 150, 155 are made coaxial, such that a solid shaft runs inside a hollow shaft. It is preferable for whichever input shaft 150, 155 is transmitting torque in gear step 1 (see FIG. 2) to be a solid shaft. When the double transmission 110 is used, for example in a truck, this gear step can be used for starting off from rest.

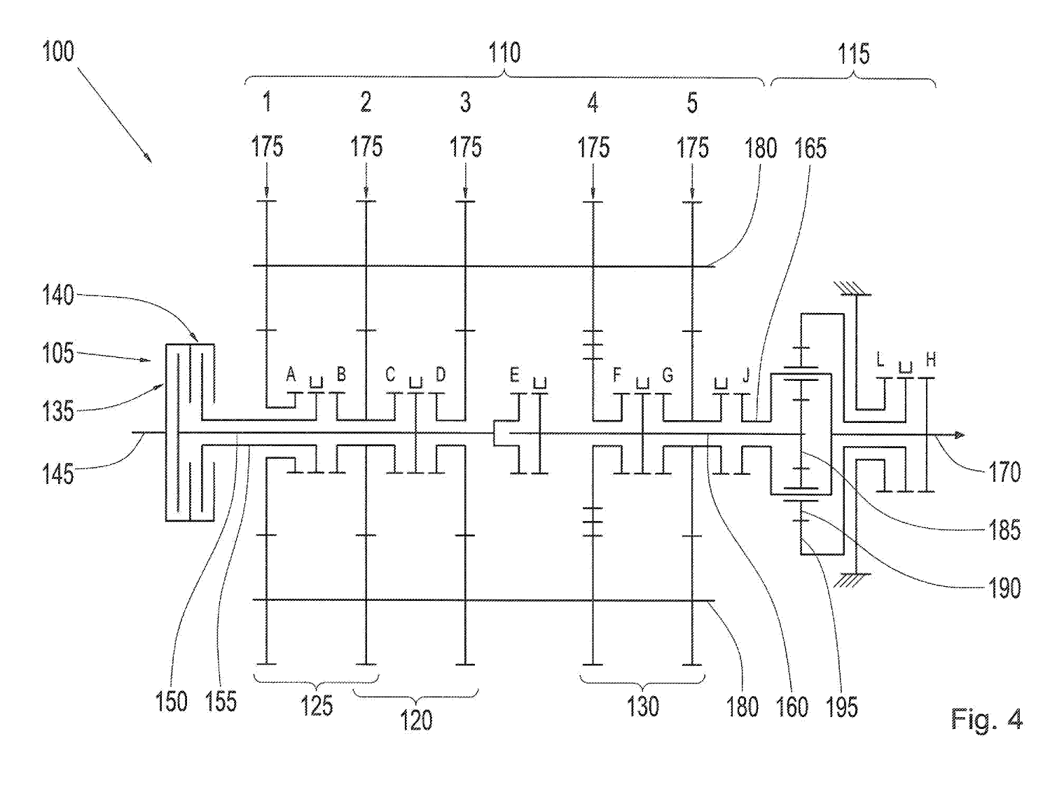

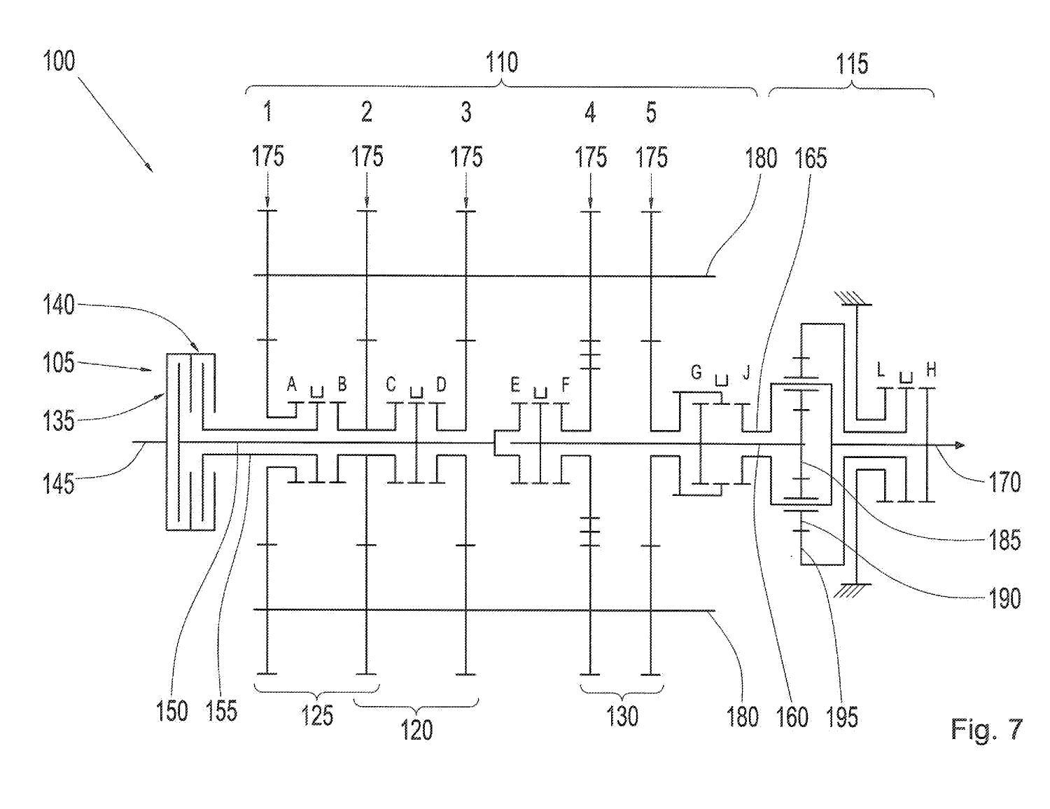

An output side of the double transmission 110 is formed by an intermediate shaft 160, which acts upon an input side of the group transmission 115. A second intermediate shaft 165, which can provide an alternative power transfer between the double transmission 110 and the group transmission 115 (see FIGS. 4 and 7), is not present in the embodiment shown. On its output side, the group transmission 115 acts upon a drive output shaft 170, which can be the same as the first intermediate shaft 160 if the group transmission 115 is omitted.

The first sub-transmission 120 is associated with the first input shaft 150 and the second sub-transmission 125 with the second input shaft 155. In the embodiment illustrated, the sub-transmissions 120, 125 each comprise two gearsets 175, each of them comprising the two gearwheels that mesh with one another, one of these gearwheels in each case acting upon a countershaft 180. As shown in FIG. 1 a plurality of countershafts 180 each with associated gearsets 175 can be used, in order to increase the load-bearing capacity of the double transmission 110.

To selectively form or break torque flow between the countershaft 180 and one of the shafts 150, 155 or 165, shifting elements A to G, H and L are provided. Each shifting element A to L is designed to either make or break a torque-transmitting connection. In this case an only partial transfer of torque, in particular by means of friction, is not provided, but rather, an interlocked engagement is made or broken by axial displacement of a shifting or coupling element. In the embodiment shown the shifting elements A, B, C, D, F and G act in each case between a gearwheel of a gearset 175 and one of the shafts 150, 155 and 165. The respective corresponding gearwheels of the gearsets 175 are connected permanently to the countershaft 180. A converse arrangement, in which a shifting element makes or breaks the torque flow through the countershaft 180, is also possible. The shifting element E is designed to make or break a torque flow between the first input shaft 150 and the first intermediate shaft 160.

The group transmission 115 is preferably in the form of an epicyclic transmission shown as an example in FIG. 1 as a planetary gearset with a sun gear 185, a planetary gear 190 and a ring gear 195. In other embodiments, however, another type of gearing can be used for the group transmission 115. In the embodiment of the group transmission 115 shown, torque can be coupled by means of the first intermediate shaft 160 to the sun gear 185 and decoupled by means of the planetary gear or a planetary carrier at the drive output shaft 170. In a first operating condition the ring gear 195 can be connected by means of the shifting element H to the first intermediate shaft 160 or the sun gear 185, so that the gear ratio of the group transmission 115 is equal to 1 (one). In a second operating condition the ring gear 195 can be braked by means of the shifting element L, so that it is at rest for example relative to a housing of the group transmission 115 and/or the double transmission 110. In that case a step-down ratio is obtained between the first intermediate shaft 160 and the drive output shaft 170. It is particularly preferable for the group transmission 115 to be designed so that it can be powershifted, i.e. the shifting element H can be released and the shifting element L closed (or conversely) while torque is transmitted continuously between the first intermediate shaft 160 and the drive output shaft 170 by the group transmission 115.

In the embodiment illustrated the gearsets 175 each comprise gearwheels with spur teeth, so that each gearset 175 lies in a rotational plane about a rotational axis, in order that the input shafts 150, 155, the first intermediate shaft 160 and if appropriate the second intermediate shaft 165, and usually also the drive input shaft 145 and/or the drive output shaft 170, are mounted in a rotatable manner. These rotational planes are also called wheel planes and in the embodiment shown are numbered from 1 to 5 from the left toward the right.

It is proposed to associate one gearset 175, in the embodiment shown the gearset 175 of the wheel plane 2, if necessary selectively with the first sub-transmission 120 or the second sub-transmission 125. In this case the two sub-transmissions 150, 155 comprise together only three gearsets 175 of the wheel planes 1, 2 and 3. If the shifting element B is closed, then the gearset 175 of wheel plane 2 is connected between the second input shaft 155 and the countershaft 180, but instead, if the shifting element C is closed, then the gearset 175 of wheel plane 2 is connected between the first input shaft 150 and the countershaft 180.

The shifting element E can on the one hand be used, when the first friction clutch 135 is closed, to engage a direct gear so that the drive input shaft 145 rotates at the same speed as the first intermediate shaft 160. There should be no permanent connection of the direct gear to the countershaft 180, so as to design the direct gear in a pre-selectable manner. If instead the second friction clutch 140 is closed, then instead of the third sub-transmission 130, the first sub-transmission 120 can be used to transmit torque from the countershaft 180 to the first intermediate shaft 160. For this, one of the shifting elements C or D and one of the shifting elements A or B is closed, but the shifting elements B and C may not be closed at the same time. Torque from the drive input shaft 145 is then transmitted via the second friction clutch 140 to the second intermediate shaft 165, from there via a gearset 175 of one of the wheel planes 1 or 2 to the countershaft 180, onward via one of the gearsets 175 of the wheel planes 2 or 3 to the first input shaft 150 and farther onward via the shifting element E to the first intermediate shaft 160.

In the preferred embodiment illustrated, the third sub-transmission 130 has two gearsets 175 of the wheel planes 4 and 5. One of the gearsets 175, in wheel plane 5 in the embodiment shown, has three instead of two gearwheels that mesh with one another so that the gearset 175 has the same rotational direction on its input side and on its output side. In contrast to the other, reversing gearsets 175, whose gearwheels rotate in pairs in different directions, in this case the gearset 175 of wheel plane 5 is of non-reversing design in order to produce one or more reversing gears of the double transmission 110.

FIG. 2 shows a shifting matrix 200 for the dual-clutch transmission 100 of FIG. 1 In columns from left to right a gear step Gg and shift conditions of the first friction clutch 135 (K1), the second friction clutch 140 (K2) and the shifting elements A to G and L and H are shown. On the right next to these, in further columns, an overall gear ratio i and a gear interval φ are entered. Examples of the overall gear ratios that can be obtained with appropriately sized gearsets 175 are indicated. The overall gear ratio i shows the ratio of the rotational speed of the drive input shaft 145 relative to the rotational speed of the drive output shaft 170 of the dual-clutch transmission 100. The gear interval φ denotes the ratio of the overall gear ratios i of neighboring gear steps Gg.

In the shifting matrix 200, in columns A-G, L, H a dot denotes respectively a closed connection of the respective switching element, otherwise the respective connection is open. In the case of the friction clutches 135, 140 when a dot is shown it is assumed that a torque flow is enabled, usually by static friction without slip. A transition between the indicated gear ratios, in particular without interruption of traction, may require a slipping friction clutch 135, 140.

The gears Gg are numbered from 1 to 14 for forward gears and from R1 to R3 for reversing gears. In this case the gears 3, 10 and R3 are double-engaged. The overall gear ratios i of the double-engaged gears Gg are equal in pairs and differ on the one hand in which of the friction clutches 135, 140 and on the other hand in which of the shifting elements B and C is closed. If the shifting element B is closed, then the number of the gear step is marked with b, while in contrast, if the shifting element C is closed the number of the gear step has c attached. A transition between the double-engaged gear steps 3, 10 and R3 from one variant to the respective other variant is possible at any time without traction force interruption. Thus, the gear steps 3, 10 and R3 can each be operated alternatively by way of the first friction clutch 135 or by way of the second friction clutch 140.

The main transmission can be shifted through the following transitions without traction force interruption: 20 2; 1↔3a; 1↔5; 2↔1; 2↔3c; 2↔5; 3b↔1; 3c↔2; 3b↔5; 4↔5; 5↔2; 5↔3b; 5↔4; 5↔6; 5↔7; 6↔5 and 7↔5. For shifts between the gears 2 and 4 and the gears 3 and 4, supporting gears can be engaged: 2↔5↔4; 3b↔5↔4. Thus the main transmission 110 can be fully powershifted sequentially between gears 1 and 6: 1↔2↔3c↔3b↔(5)↔4↔5↔6.

The gear steps 13 and 14 have an overall gear ratio i smaller than 1 and are therefore also called overdrive gears (OD). Fourteen gear steps 1-14 are obtained since, by means of the double transmission 110, seven different gears for each of the two conditions of the group transmission 115 can be engaged. Thus, the dual-clutch transmission 100 of FIG. 1 is also termed a 7×2 2OD configuration. In this, reversing gears are not counted. To carry out a shift without traction force interruption from one gear step Gg to another, both of the gears Gg are engaged by means of the shifting elements A to L, while only one of the friction clutches 135, 140 is closed so that only one of the gears Gg is effective. Then the closed friction clutch 135, 140 is opened and the open friction clutch 135, 140 is closed. The one friction clutch 135, 140 is opened and the other friction clutch 135, 140 is dosed preferably simultaneously, so that a shift between the engaged gears Gg takes place without traction force interruption.

In the embodiment illustrated such a shift between gears 7 and 8 or between gears 13 and 14 is not directly possible. A shift between gears 3 and 4 or 10 and 11 can be made without traction force interruption by temporarily engaging gear 5 for a short time and partially closing the associated friction clutch 135. Here, gear 5 is used as a so-termed supporting gear. Between gear 3 and gear 4 a powershift can be carried out as follows: (3a↔) 3b↔5↔4. In a corresponding manner a shift can be carried out between gears 10 and 11: (10a↔) 10b↔12↔11. To enable the engagement of the supporting gear it is preferable to be able to make the countershaft 180 completely free from torque by means of the shifting elements A-G.

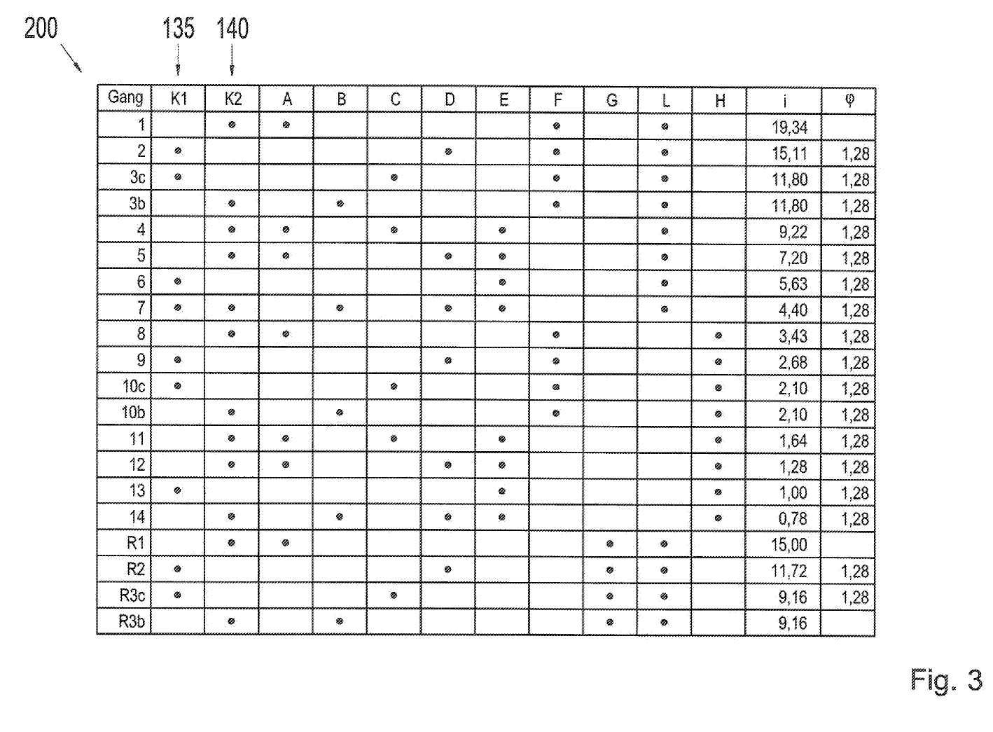

FIG. 3 shows a shifting matrix 200 for the dual-clutch transmission 100 of FIG. 1, which can be used instead of the shifting matrix 200 of FIG. 2. By means of supporting gear shifts, the following transitions can be carried out without traction force interruption: (3a↔) 3b↔6↔4; 4↔6↔5; (10a↔) 10b↔13↔11 and 11↔13↔12. A transition between the double-engaged gear steps 3, 10 and R3 from one variant to the respective other variant is possible at any time without traction force interruption.

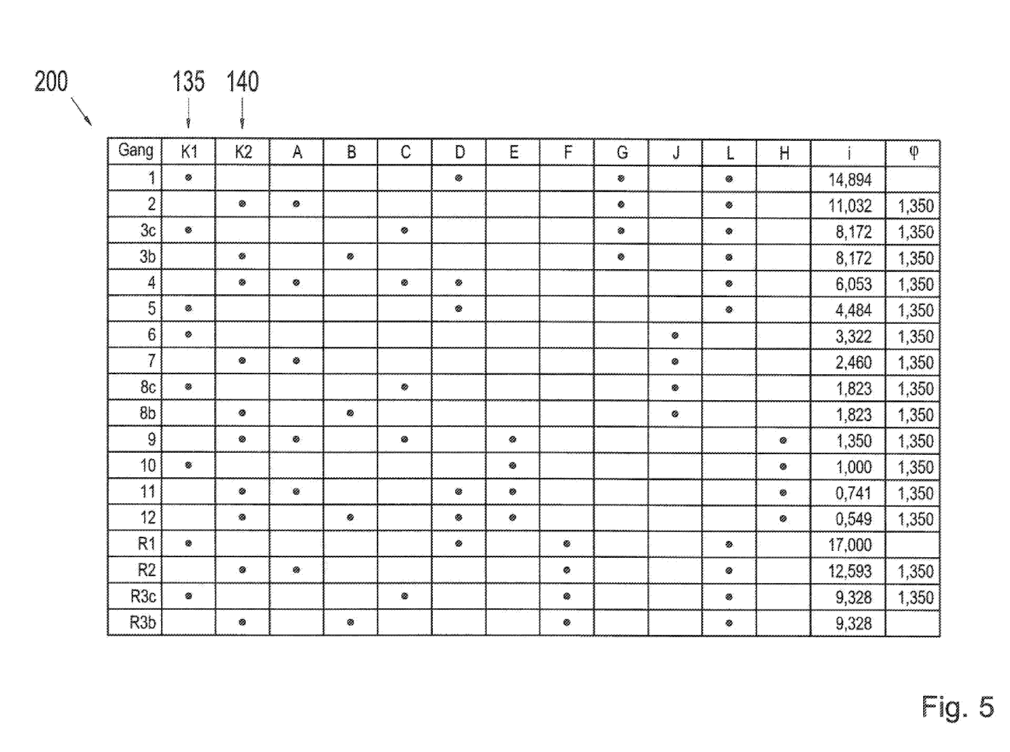

FIG. 4 shows a further embodiment of a dual-clutch transmission 100 according to FIG. 1, wherein a powershiftable group transmission 115 is provided. An appropriate shifting matrix 200 for the configuration 12×1 2OD is shown in FIG. 5. The overall gear ratios i shown again relate to gearsets 175 whose dimensions are taken as examples.

Compared with the embodiment according to FIG. 1, the gearsets 175 of wheel planes 4 and 5 have been interchanged and the second intermediate shaft 165 can be connected in a shiftable manner by means of an additional shifting element J to the gearset 175 of wheel plane 5 of the third sub-transmission 130. The second intermediate shaft 165 acts by way of a planetary carrier on the planetary gear 190 of the group transmission 115 and the planetary carrier acts directly on the drive output shaft 170. By means of the shifting element L the ring gear 195 can be braked for example relative to a housing or some other static device, so that it is at rest, or by means of the shifting element H it can be connected to the drive output shaft 170 and to the planetary carrier of the planetary gear 190.

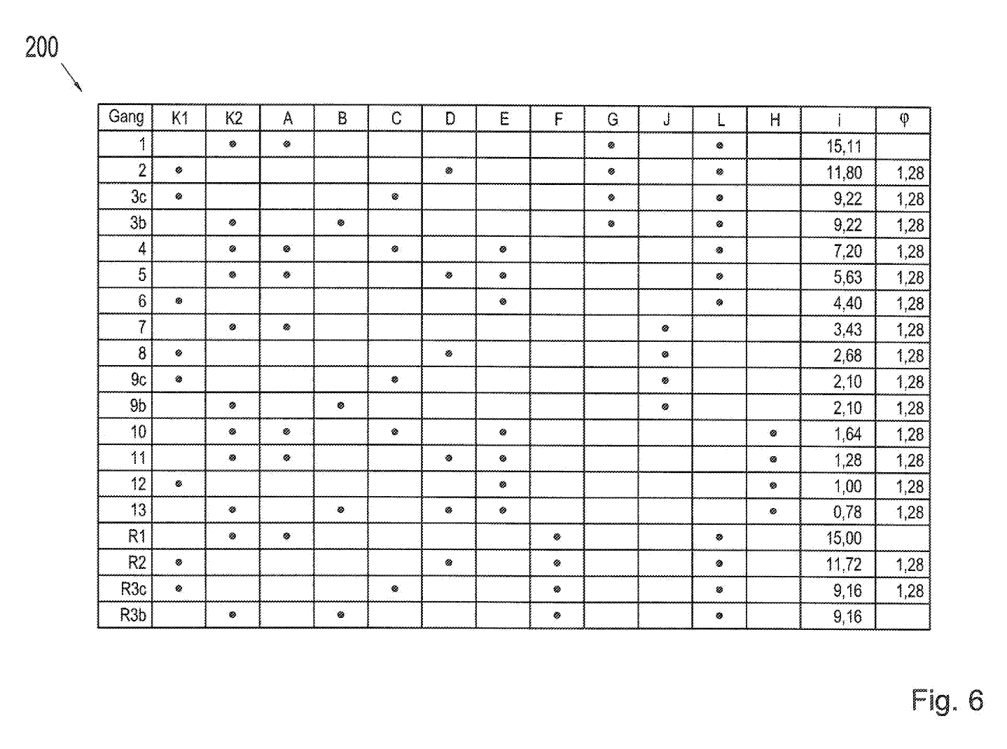

FIG. 6 shows a shifting matrix 200 for the dual-clutch transmission 100 in the embodiment of FIG. 4, such that the shifting matrix 200 shown can be used as an alternative to that shown in FIG. 5. In this case the wheel planes 1 and 3 are interchanged and the dual-clutch transmission 100 is operated in a 13×1 2OD configuration. The shifting element J can be used in combination with a powershiftable group transmission 115. A transition between the double-engaged gear steps 3, 9 and R3 from the variant concerned to the respective other variant can be carried out at any time without traction force interruption.

FIG. 7 shows still another embodiment of the dual-clutch transmission 100 of FIG. 1. In contrast to the embodiment shown in FIG. 4, in this case the shifting elements E, F, G and J are combined in a different way. Again, a powershiftable group transmission 115 is provided. Whereas in the embodiment of FIG. 4 the shifting elements E and J are single shifting elements and the shifting elements F and G are integrated with one another, in this case the shifting elements E and F respectively and G and J respectively are integrated. In that way the overall number of elements that have to be moved in order to engage a gear in the double transmission 110 is reduced.

The shifting matrix 200 for the embodiment shown corresponds to that of FIG. 5, so that the configuration is 12×1 2OD, or to that of FIG. 6 with the configuration 13×1 1OD,

### INDEXES

100 Dual-clutch transmission
105 Dual clutch
110 Double transmission (main transmission)
115 Group transmission
120 First sub-transmission
125 Second sub-transmission
130 Third sub-transmission
135 First friction clutch
140 Second friction clutch
145 Drive input shaft
150 First input shaft
155 Second input shaft
160 First intermediate shaft
165 Second intermediate shaft
170 Drive output shaft
175 Gearset
180 Countershaft
185 Sun gear
190 Planetary gear
195 Ring gear
A-G, J, H, L Shifting element
1-5 Wheel plane
i Overall gear ratio
Gg Gear step
φ Gear interval
200 Shifting matrix

1-12. (canceled)

13. A double clutch transmission (110) comprising:
a first input shaft (150);
a second input shaft (155);
a countershaft (180);
a drive output shaft (170);
a first sub-transmission (120) with two gearsets (175), of which one gearset is selectively connectable to transmit torque between the first input shaft (150) and the countershaft (180);
a second sub-transmission (125) with two gearsets (175), of which one gearset is selectively connectable to transmit torque between the second input shaft (155) and the countershaft (180);
a third sub-transmission (130) with one gearset (175), which is connectable to transmit torque between the countershaft (180) and the drive output shaft (170); and
one of the gearsets (175) of the first sub-transmission (120) coincides with one of the gearsets (175) of the second sub-transmission (125).

14. The double clutch transmission (110) according to claim 13, further comprising a shifting element (E) for connecting the first input shaft (150) to a first intermediate shaft (160) for transmitting torque, and the first intermediate shaft acts upon the drive output shaft (170).

15. The double clutch transmission (110) according to claim 13, wherein the third sub-transmission (130) has two gearsets (175), of which one gearset is selectively connectable to transmit torque between the countershaft (180) and the drive output shaft (170) and one of the gearsets (175) of the third sub-transmission is designed to be a non-reversing gearset.

16. The double clutch transmission (110) according to claim 14, further comprising a group transmission (115) with two gearsets (175), of which either one of the two gearsets is connectable to transmit torque between the first intermediate shaft (160) and the drive output shaft (170).

17. The double clutch transmission (110) according to claim 16, wherein the group transmission (115) comprises a planetary gearset with a sun gear (185), a planetary gear (190) and a ring gear (195), the sun gear (185) is permanently connected to the first intermediate shaft (160) and the planetary gear (190) is permanently connected to the drive output shaft (170), and the ring gear (195) is shiftable either to be at rest or to transmit torque to the first intermediate shaft (160).

18. The double clutch transmission (110) according to claim 13, further comprising a shifting element for connecting a gearset (175) of the third sub-transmission (130) to transmit torque to a second intermediate shaft (165), and a group transmission (115) with two gearsets (175), of which, either one of the two gearsets is connectable to transmit torque between the first intermediate shaft (160) and the drive output shaft (170), or the other can be connected to transmit torque between the second intermediate shaft (165) and the drive output shaft (170).

19. The double clutch transmission (110) according to claim 18, wherein the group transmission (115) comprises a planetary gearset with a sun gear (185), a planetary gear (190) and a ring gear (195), wherein the sun gear (185) is connected to the first intermediate shaft (160) and the planetary gear (190) is connected to the drive output shaft (170), and the ring gear is shiftable either to be at rest or to transmit torque to the drive output shaft (170).

20. The double clutch transmission (110) according to claim 13, wherein a gearset (175) of one of the first, the second and the third sub-transmissions (120, 125, 130) comprises a spur gear system having at least two gearwheels.

21. The double clutch transmission (110) according to claim 13, wherein a shifting element is designed to either form or break an interlocked, torque-transmitting connection between a shaft and a gearset (175) or another shaft.

22. The double clutch transmission (110) according to claim 13, further comprising a first friction clutch for connecting a drive input shaft to the first input shaft (150) and a second friction clutch for connecting the drive input shaft to the second input shaft (155).

23. The double clutch transmission (110) according to claim 13, further comprising a control unit for controlling shifting elements which are each designed for a torque-transmitting connection of a gearset (175) or for a torque-transmitting connection of two shafts within the transmission.

24. A method of engaging an overall gear ratio in a double clutch transmission (110) having a first input shaft (150) and a second input shaft (155); a countershaft (180); a drive output shaft (170); a first sub-transmission (120) with two gearsets (175), of which one is selectively connectable to transmit torque between the first input shaft (150) and the countershaft (180); a second sub-transmission (125) with two gearsets (175), of which one in selectively connectable to transmit torque between the second input shaft (155) and the countershaft (180); a third sub-transmission (130) with one gearset (175) which is connectable to transmit torque between the countershaft (180) and the drive output shaft (170); and one of the gearsets (175) of the first sub-transmission (120) coincides with one of the gearsets (175) of the second sub-transmission (125), the method comprising:
engaging a first overall gear ratio between one of the input shafts (150, 155) and the drive output shaft (170) and a second overall gear ratio between the other input shaft (150, 155) and the drive output shaft (170),
controlling a shift from the first to the second overall gear ratio by first and second friction clutches, wherein the overall gear ratios are engaged, respectively, either by the torque-transmitting connection of just one of the gearsets (175) of the first (120) or the second (125) sub-transmission between one of the input shafts (150, 155) and the countershaft (180) and by the torque-transmitting connection of just one gearset (175) of the third sub-transmission (130) between the countershaft (180) and the first intermediate shaft (160); or by the torque-transmitting connection of just one gearset (175) of the second sub-transmission (125) between the second input shaft (155) and the countershaft (180), by the torque-transmitting connection of just one gearset (175) of the first sub-transmission (120) between the countershaft (180) and the second input shaft (155), and by the torque-transmitting connection of the first input shaft (150) to the first intermediate shaft (160).

25. A double clutch transmission (110) comprising:
a first input shaft (150);
a second input shaft (155);
a countershaft (180);
a drive output shaft (170);
a first sub-transmission (120) having two gearsets (175), one of the two gearsets of the first sub-transmission is selectively connectable to transmit torque between the first input shaft (150) and the countershaft (180);
a second sub-transmission (125) having two gearsets (175), one of the two gearsets of the second sub-transmission is selectively connectable to transmit torque between the second input shaft (155) and the countershaft (180);
a third sub-transmission (130) with one gearset (175), and the gearset of the third sub-transmission being connectable to transmit torque between the countershaft (180) and the drive output shaft (170); and
one of the two gearsets (175) of the first sub-transmission (120) being the same as one of the two gearsets (175) of the second sub-transmission (125).
